(19) United States
(12) Patent Application Publication
(10) Pub. No.: US 2024/0297788 A1
(43) Pub. Date: Sep. 5, 2024

(54) SYSTEMS AND METHODS FOR REAL-TIME PERMISSIONING FOR DIGITAL RESOURCES IN A DISTRIBUTED COMPUTING SYSTEM

(71) Applicant: BANK OF AMERICA CORPORATION, Charlotte, NC (US)

(72) Inventors: Suzanna Binte Ismail, Singapore (SG); Ryan Nielsen, Denver, CO (US)

(73) Assignee: BANK OF AMERICA CORPORATION, Charlotte, NC (US)

(21) Appl. No.: 18/116,400

(22) Filed: Mar. 2, 2023

(51) Int. Cl. H04L 9/32; H04L 9/16

(52) U.S. Cl. CPC H04L 9/3213; H04L 9/16; H04L 9/3234

(57) ABSTRACT

Embodiments of the invention are directed to systems, methods, and computer program products for generation of dynamic authentication tokens for use in system-to-system access authorization and user identity verification. The system includes receiving, from a user device associated with a user, a first data transmission, wherein the first data transmission comprises one or more first datasets associated with the user; applying an encryption algorithm to each first dataset to generate an encrypted dataset; configuring the encrypted dataset into an authentication token; transferring the authentication token to one or more entity systems; and receiving, from the user device, a second data transmission, wherein the second data transmission comprises a request to access a resource and a second dataset associated with the user.

### BACKGROUND

When a user wishes to access data between multiple systems or applications, a set of authentication credentials such as a username, password, or multi-factor authentication code is typically required for each system or application, especially in scenarios related to the exchange of sensitive data. Said authentication credentials may be difficult to remember and highly labor intensive for a user to provide. Additionally, they are highly susceptible to being compromised in a data breach. As such, a need exists for a system which eliminates the need for user involvement in the authentication process by utilizing system-to-system authentication credential exchange.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for generation of authentication tokens, the invention comprising: receiving, from a user device associated with a user, a first data transmission, where the first data transmission includes one or more first datasets associated with the user; applying an encryption algorithm to each first dataset to generate an encrypted dataset; configuring the encrypted dataset into an authentication token; transferring the authentication token to one or more entity systems; and receiving, from the user device, a second data transmission, where the second data transmission includes a request to access a resource and a second dataset associated with the user.

In some embodiments, the invention further includes detecting, based on monitoring an application of the user device, a request for resource access between the one or more entity systems and at least one of the user device and the managing entity system; causing the at least one of the user device and the managing entity system to transmit a user dataset stored at the at least one of the user device and the managing entity system to the one or more entity systems; causing the one or more entity systems to verify that the transmitted user dataset matches the authentication token transferred to the one or more third party systems; and causing the one or more entity systems to authorize the request for resource access.

In some embodiments, the invention further includes receiving, from at least one of the managing entity system, the user device, and the one or more entity systems, instructions to recall the authentication token from the managing entity system, the user device, or the one or more entity systems; and revoking access of the authentication token from the managing entity system, the user device, or the one or more entity systems.

In some embodiments, the invention further includes receiving, from at least one of the managing entity system, the user device, and the one or more entity systems, instructions to enable access of the authentication token to the managing entity system, the user device, or the one or more entity systems; and enabling access of the authentication token to the managing entity system, the user device, or the one or more entity systems.

In some embodiments, the second data transmission is received via a short range communication channel between a user access device and an entity device.

In some embodiments, the user access device includes at least one of: a mobile device, an access card, a key, or a key fob.

In some embodiments, the user device is associated with a first distributed computing system and the resource is stored in a second distributed computing system.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1A-1C illustrate technical components of an exemplary distributed computing environment for generating authentication tokens, in accordance with an embodiment of the disclosure;

FIG. 2A illustrates an exemplary process of generating an authentication token, in accordance with an embodiment of the disclosure;

FIG. 2B illustrates an exemplary authentication token, in accordance with an embodiment of the disclosure;

FIG. 3 is a flow diagram illustrating a process using the token generation system, in accordance with an embodiment of the disclosure; and

FIG. 4 is a flow diagram illustrating a process using the token generation system, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. In some instances described herein, the user is an individual who seeks to utilize, operate, or perform one or more activities associated with a computer terminal, typically based on successful validation of the user's authentication credentials. In some embodiments, a “user” may be an employee (e.g., a technology operator/technician, an associate, a project manager, an IT specialist, a manager, an administrator, an internal operations analyst, or the like) of the entity or enterprises affiliated with the entity, capable of operating the systems and computer terminals described herein. In other embodiments, a user may be a system or an entity performing one or more tasks described herein.

Accordingly, as used herein the term “user device” or “mobile device” may refer to mobile phones, personal computing devices, tablet computers, wearable devices, and/or any portable electronic device capable of receiving and/or storing data therein.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

“Engine” as used herein may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to teach other with one or more components located between the components that are operatively coupled together. Furthermore, “operatively coupled” may mean that the components are detachable from each other, or that they are permanently coupled together. Furthermore, “operatively coupled” may mean that components may be electronically connected.

The system described herein provides a dynamically generated authentication token for system-to-system transaction authentication and user verification. The system provides the functional benefit of eliminating the need for user-provided authentication credentials, which are not only difficult for a user to remember but are often highly susceptible to becoming compromised in a data breach. Furthermore, the system utilizes user physical data characteristics to generate said authentication tokens, which provides of the benefit of ensuring that each token is truly unique to a particular user. In some embodiments, the authentication token is a non-fungible token (“NFT”), such that usage of the NFT to authenticate a user is recorded and maintained on a decentralized distributed ledger. An NFT is a cryptographic record (referred to as “tokens”) linked to a resource. An NFT is typically stored on a distributed ledger that certifies ownership and authenticity of the resource, and exchangeable in a peer-to-peer network. As such, a managing entity or other entity system may be able to monitor usage trends and detect potential security threats. In addition, the present invention provides the functional advantage of allowing a managing entity system to immediately and reversibly terminate or enable user access to a wide variety of other systems, locations, and/or applications in real time, by altering the relationship layers of the NFTs. Overall, the system provides a more secure and more efficient method of authenticating data exchange between multiple systems or applications.

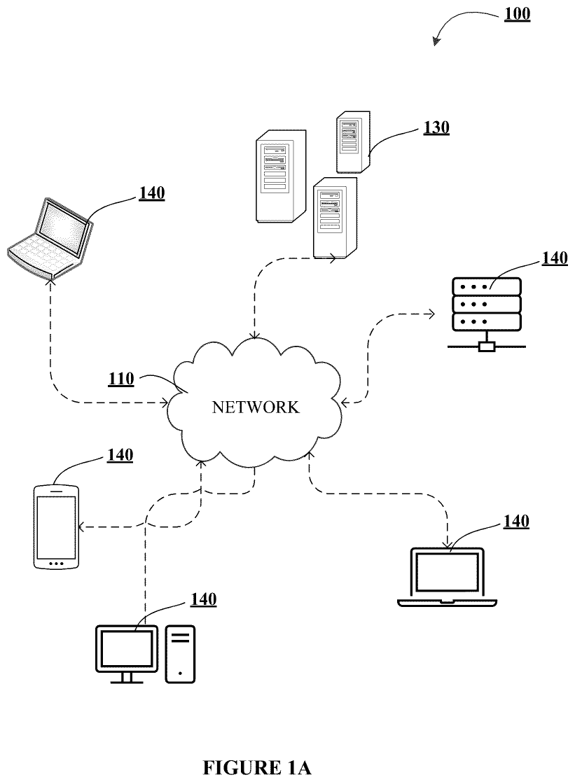

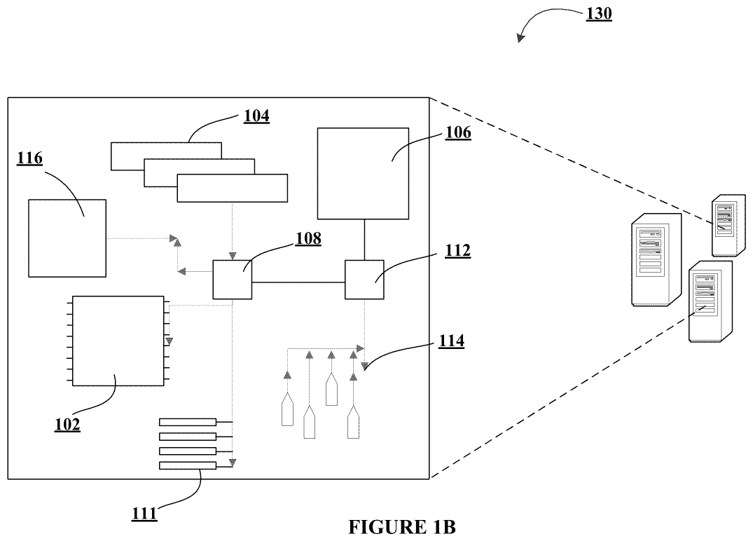

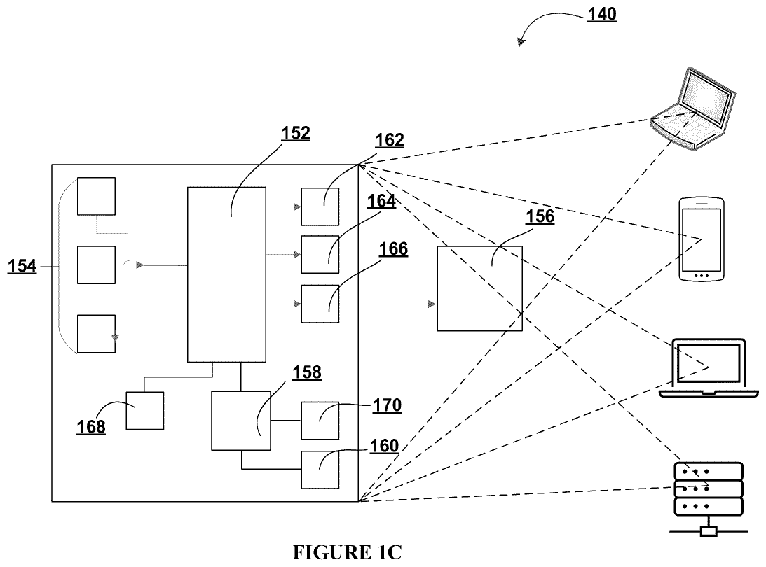

FIGS. 1A-1C illustrate technical components of an exemplary distributed computing environment for generation of authentication tokens 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

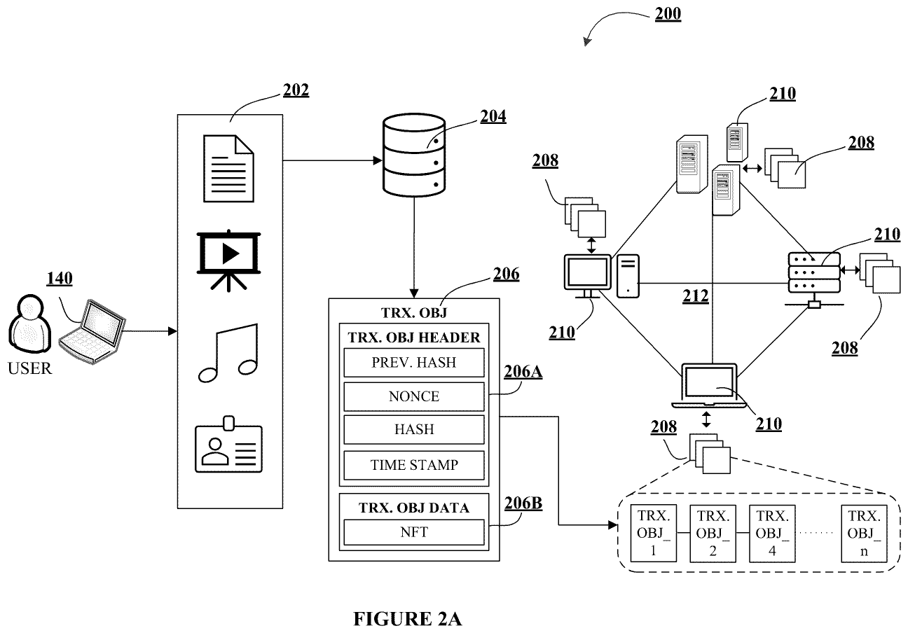

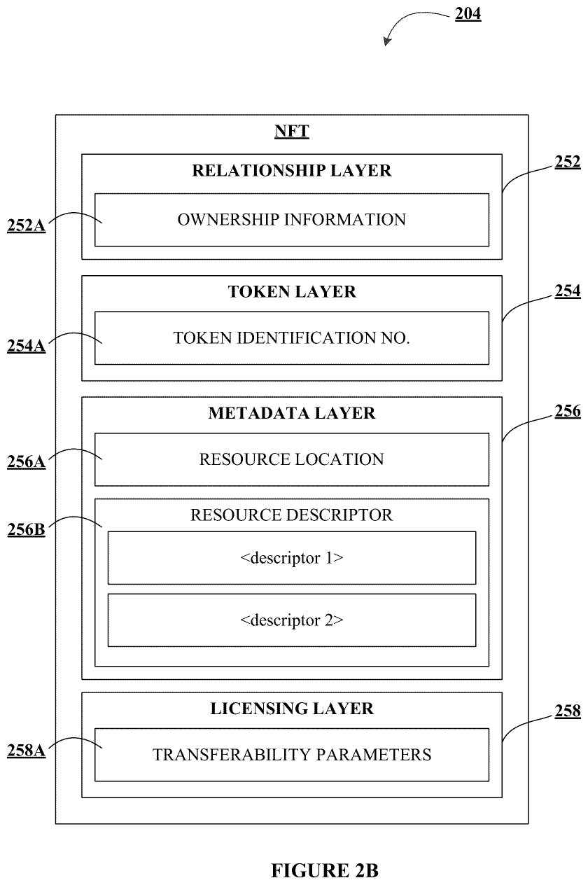

FIG. 2A illustrates an exemplary process of creating an NFT 200, in accordance with an embodiment of the invention. As shown in FIG. 2A, to create or “mint” an NFT, a user (e.g., NFT owner) may identify, using a user input device 140, resources 202 that the user wishes to mint as an NFT. Typically, NFTs are minted from digital objects that represent both tangible and intangible objects. These resources 202 may include a piece of art, music, collectible, virtual world items, videos, real-world items such as artwork and real estate, or any other presumed valuable object. In the present invention, the resources 202 may comprise authentication credentials such as usernames, passwords, PINs, and/or physical datasets such as fingerprints, voice samples, facial scans, and/or the like. These resources 202 are then digitized into a proper format to produce an NFT 204. The NFT 204 may be a multi-layered documentation that identifies the resources 202 but also evidences various transaction conditions associated therewith, as described in more detail with respect to FIG. 2A.

To record the NFT in a distributed ledger, a transaction object 206 for the NFT 204 is created. The transaction object 206 may include a transaction header 206A and a transaction object data 206B. The transaction header 206A may include a cryptographic hash of the previous transaction object, a nonce-a randomly generated 32-bit whole number when the transaction object is created, cryptographic hash of the current transaction object wedded to the nonce, and a time stamp. The transaction object data 206B may include the NFT 204 being recorded. Once the transaction object 206 is generated, the NFT 204 is considered signed and forever tied to its nonce and hash. The transaction object 206 is then deployed in the distributed ledger 208. At this time, a distributed ledger address is generated for the transaction object 206, i.e., an indication of where it is located on the distributed ledger 208 and captured for recording purposes. Once deployed, the NFT 204 is linked permanently to its hash and the distributed ledger 208, and is considered recorded in the distributed ledger 208, thus concluding the minting process

As shown in FIG. 2A, the distributed ledger 208 may be maintained on multiple devices (nodes) 210 that are authorized to keep track of the distributed ledger 208. For example, these nodes 210 may be computing devices such as system 130 and end-point device(s) 140. One node 210 may have a complete or partial copy of the entire distributed ledger 208 or set of transactions and/or transaction objects on the distributed ledger 208. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 2B illustrates an exemplary NFT 204 as a multi-layered documentation of a resource, in accordance with an embodiment of an invention. As shown in FIG. 2B, the NFT may include at least relationship layer 252, a token layer 254, a metadata layer 256, and a licensing layer 258. The relationship layer 252 may include ownership information 252A, including a map of various users that are associated with the resource and/or the NFT 204, and their relationship to one another. For example, if the NFT 204 is purchased by buyer B1 from a seller S1, the relationship between B1 and S1 as a buyer-seller is recorded in the relationship layer 252. In another example, if the NFT 204 is owned by 01 and the resource itself is stored in a storage facility by storage provider SP1, then the relationship between 01 and SP1 as owner-file storage provider is recorded in the relationship layer 252. The token layer 254 may include a token identification number 254A that is used to identify the NFT 204. The metadata layer 256 may include at least a file location 256A and a file descriptor 256B. The file location 256A may provide information associated with the specific location of the resource 202. Depending on the conditions listed in the smart contract underlying the distributed ledger 208, the resource 202 may be stored on-chain, i.e., directly on the distributed ledger 208 along with the NFT 204, or off-chain, i.e., in an external storage location. The file location 256A identifies where the resource 202 is stored. The file descriptor 256B may include specific information associated with the source itself 202. For example, the file descriptor 256B may include information about the supply, authenticity, lineage, provenance of the resource 202. The licensing layer 258 may include any transferability parameters 258B associated with the NFT 204, such as restrictions and licensing rules associated with purchase, sale, and any other types of transfer of the resource 202 and/or the NFT 204 from one person to another. Those skilled in the art will appreciate that various additional layers and combinations of layers can be configured as needed without departing from the scope and spirit of the invention.

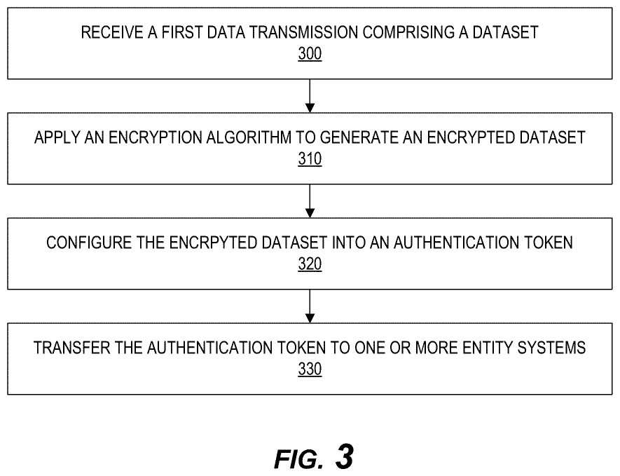

FIG. 3 is a high-level process flow diagram illustrating a process using the token generation system, in accordance with one embodiment of the present disclosure. The process may begin at block 300, wherein in some embodiments, the system receives a data transmission from a user device, or end-point device 140. The data transmission may comprise a plurality of physical datasets of a user 102 associated with the user device 104 and may further comprise any type of physical data obtained from a user input device 340 such as a fingerprint, facial scan, iris scan, voice sample, and/or the like. Additionally or alternatively, the system may receive a data transmission from a managing entity system, wherein the data transmission comprises physical data of a user 102. After receipt of the data transmission, the system may store the physical datasets of the user 102 in a datastore.

The process may then continue to block 310, wherein the system applies, via an encryption engine, a series of encryption algorithms to at least one subset of the physical data associated with a user 102. The encryption algorithms may be dynamic, rotating algorithms such that at any given point in time, the subset of physical data used as well as the types of algorithms applied to each dataset in the subset may vary. By rotating both the encryption algorithms used, as well as the pieces of data being encrypted, the system provides a high level of security such that even if a user's physical data was compromised, it would be highly unlikely that an attacker would be able to recreate the encrypted dataset stemming from said physical data at any given point in time. The process may then continue to block 520, wherein the system may configure the encrypted dataset into an authentication token, or NFT, as is discussed in greater detail with respect to FIGS. 2A and 2B.

The process may then continue to block 530, wherein the system may transfer access to the authentication token to one or more entity systems. In some embodiments, the system may transfer access by configuring one or both of the relationship layer 252 and licensing layer 258 of the authentication token. In some embodiments, the system may determine the one or more entity systems based on user data such as user type, user location, user role, and/or the like. For example, the system may determine that the user is located in a first location, such as a managing entity headquarters. The system may further determine, based on user data, that the user will be located in a second location, such as a manufacturing plant, for a predetermined period of time. As such, the system may configure the licensing layer 258 of the authentication token such that during the predetermined period of time, a computing system of the second location has access to the authentication token and will be able to verify the user's identity when the user is present at the second location. In another example, the system may determine that the user has a user role, such as a customer support representative. The system may further determine, based on the user role, that the user will require access to an external system, such as a client computing system, for a predetermined period of time. As such, the system may configure the licensing layer 258 of the authentication token such that during the predetermined period of time, the client computing system has access to the authentication token and will be able to verify the user's identity when the user attempts to connect to the client system.

In some embodiments, the process may continue to block 340, wherein the system receives, from the user device, a second data transmission, wherein the second data transmission comprises a request to access a resource and a second dataset associated with the user. The second dataset associated with the user may comprise a set of physical data. In some embodiments, the user device may be associated with a first distributed computing system, such as a managing entity system, and the resource may be stored in a second distributed computing system, such as an external system or a system requiring secondary authentication credentials. In some embodiments, the request to access the resource may be a request for physical access, such as building access, room access, and/or the like. As such, the second data transmission may be received via a short range communication channel (e.g. NFC, Bluetooth, and/or the like) between a user access device and an entity system or device. In some embodiments, the user access device may comprise a mobile device, an access card, a key, a key fob, and/or the like. Additionally or alternatively, the user may interact directly with the entity device by providing a fingerprint scan, facial scan, voice sample, and/or the like.

In some embodiments, the system may receive, from the managing entity system, the user device, and/or the one or more entity systems, instructions to recall access and/or enable access relating to the authentication token. As such, the system may configure the relationship and/or licensing layers of the authentication token in order to quickly alter the user's access to various systems and devices in real time.

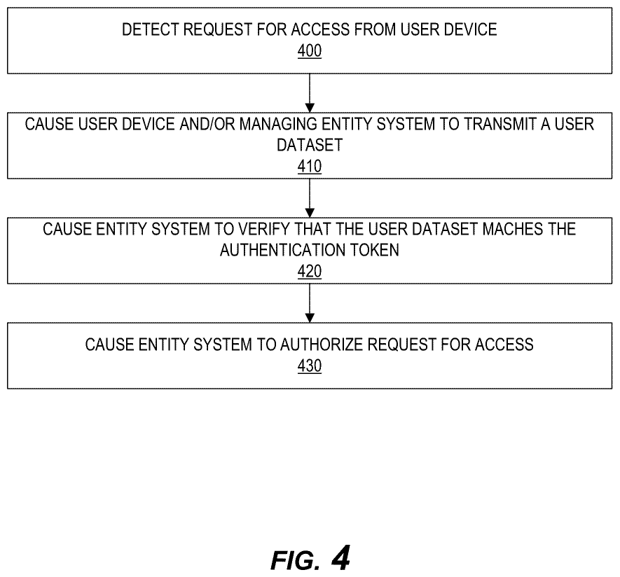

FIG. 4 is a high-level process flow diagram illustrating a process using the token generation system, in accordance with another embodiment of the present disclosure. The process begins at block 400, wherein the system monitors the user device and/or an application of the user device and detects a request by the user for access and/or information exchange between the user device, the managing entity system, and one or more entity systems. The request for access may comprise a request to log into an account, view entity information, access a physical location, complete a workflow, and/or the like. The request for information exchange may comprise a transaction request, authorization request, a request for user or account information to be transferred between the managing entity system and an entity system, and/or the like. In some embodiments, the request for access and/or information exchange may further comprise a set of user authentication credentials such as a username and/or password or may comprise a transmission of physical data such as a fingerprint scan or the like.

The process may then continue to block 410, wherein in some embodiments, the system causes the user device and/or the managing entity system to transmit a user dataset stored at the user device and/or the managing entity system to the entity party system. The user dataset may comprise stored physical data associated with the user. Additionally or alternatively, the system may cause the entity system to send a request to the user device and/or the managing entity system for a stored dataset associated with the user.

The process may then continue to block 420, wherein the system causes the entity system to verify that the user dataset is correctly associated with the authentication token. If the received user dataset matches the data used to generate the authentication token, the system may allow the entity system to approve or authorize the request for access and/or information exchange, as illustrated by block 430.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for generation of authentication tokens, the system comprising:
a memory device with computer-readable program code stored thereon;
a communication device;
a processing device operatively coupled to the memory device and the communication device, wherein the processing device is configured to execute the computer-readable program code to:
receive, from a user device associated with a user, a first data transmission, wherein the first data transmission comprises one or more first datasets associated with the user;
apply an encryption algorithm to each first dataset to generate an encrypted dataset;
configure the encrypted dataset into an authentication token;
transfer the authentication token to one or more entity systems; and
receive, from the user device, a second data transmission, wherein the second data transmission comprises a request to access a resource and a second dataset associated with the user.

2. The system of claim 1, wherein the processing device is further configured to execute the computer-readable program code to:
detect, based on monitoring an application of the user device, a request for resource access between the one or more entity systems and at least one of the user device and the managing entity system;
cause the at least one of the user device and the managing entity system to transmit a user dataset stored at the at least one of the user device and the managing entity system to the one or more entity systems;
cause the one or more entity systems to verify that the transmitted user dataset matches the authentication token transferred to the one or more third party systems; and
cause the one or more entity systems to authorize the request for resource access.

3. The system of claim 1, wherein the processing device is further configured to execute the computer-readable program code to:
receive, from at least one of the managing entity system, the user device, and the one or more entity systems, instructions to recall the authentication token from the managing entity system, the user device, or the one or more entity systems; and
revoke access of the authentication token from the managing entity system, the user device, or the one or more entity systems.

4. The system of claim 1, wherein the processing device is further configured to execute the computer-readable program code to:
receive, from at least one of the managing entity system, the user device, and the one or more entity systems, instructions to enable access of the authentication token to the managing entity system, the user device, or the one or more entity systems; and
enable access of the authentication token to the managing entity system, the user device, or the one or more entity systems.

5. The system of claim 1, wherein the second data transmission is received via a short range communication channel between a user access device and an entity device.

6. The system of claim 5, wherein the user access device comprises at least one of: a mobile device, an access card, a key, or a key fob.

7. The system of claim 1, wherein the user device is associated with a first distributed computing system and wherein the resource is stored in a second distributed computing system.

8. A computer program product for generation of authentication tokens with at least one non-transitory computer-readable medium having computer-readable program code portions embodied therein, the computer-readable program code portions comprising:
an executable portion configured for receiving, from a user device associated with a user, a data transmission, wherein the data transmission comprises a plurality of biometric datasets associated with the user;
an executable portion configured for applying an encryption algorithm to each first dataset to generate an encrypted dataset;
an executable portion configured for configuring the encrypted dataset into an authentication token;
an executable portion configured for transferring the authentication token to one or more entity systems; and
an executable portion configured for receiving, from the user device, a second data transmission, wherein the second data transmission comprises a request to access a resource and a second dataset associated with the user.

9. The computer program product of claim 8, further comprising:
an executable portion configured for detecting, based on monitoring an application of the user device, a request for resource access between the one or more entity systems and at least one of the user device and the managing entity system;
an executable portion configured for causing the at least one of the user device and the managing entity system to transmit a user dataset stored at the at least one of the user device and the managing entity system to the one or more entity systems;
an executable portion configured for causing the one or more entity systems to verify that the transmitted user dataset matches the authentication token transferred to the one or more third party systems; and
an executable portion configured for causing the one or more entity systems to authorize the request for resource access.

10. The computer program product of claim 8, further comprising:
an executable portion configured for receiving, from at least one of the managing entity system, the user device, and the one or more entity systems, instructions to recall the authentication token from the managing entity system, the user device, or the one or more entity systems; and
an executable portion configured for revoking access of the authentication token from the managing entity system, the user device, or the one or more entity systems.

11. The computer program product of claim 8, further comprising:
an executable portion configured for receiving, from at least one of the managing entity system, the user device, and the one or more entity systems, instructions to enable access of the authentication token to the managing entity system, the user device, or the one or more entity systems; and
an executable portion configured for enabling access of the authentication token to the managing entity system, the user device, or the one or more entity systems.

12. The computer program product of claim 8, wherein the second data transmission is received via a short range communication channel between a user access device and an entity device.

13. The computer program product of claim 12, wherein the user access device comprises at least one of: a mobile device, an access card, a key, or a key fob.

14. The computer program product of claim 8, wherein the user device is associated with a first distributed computing system and wherein the resource is stored in a second distributed computing system.

15. A computer-implemented method for generation of authentication tokens, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a user device associated with a user, a first data transmission, wherein the first data transmission comprises one or more first datasets associated with the user;
applying an encryption algorithm to each first dataset to generate an encrypted dataset;
configuring the encrypted dataset into an authentication token;
transferring the authentication token to one or more entity systems; and
receiving, from the user device, a second data transmission, wherein the second data transmission comprises a request to access a resource and a second dataset associated with the user.

16. The computer-implemented method of claim 15, wherein the computer processing device performs the further operations of:
detecting, based on monitoring an application of the user device, a request for resource access between the one or more entity systems and at least one of the user device and the managing entity system;
causing the at least one of the user device and the managing entity system to transmit a user dataset stored at the at least one of the user device and the managing entity system to the one or more entity systems;
causing the one or more entity systems to verify that the transmitted user dataset matches the authentication token transferred to the one or more third party systems; and
causing the one or more entity systems to authorize the request for resource access.

17. The computer-implemented method of claim 15, further comprising:
receiving, from at least one of the managing entity system, the user device, and the one or more entity systems, instructions to recall the authentication token from the managing entity system, the user device, or the one or more entity systems; and
revoking access of the authentication token from the managing entity system, the user device, or the one or more entity systems.

18. The computer-implemented method of claim 15, further comprising:
receiving, from at least one of the managing entity system, the user device, and the one or more entity systems, instructions to enable access of the authentication token to the managing entity system, the user device, or the one or more entity systems; and
enabling access of the authentication token to the managing entity system, the user device, or the one or more entity systems.

19. The computer-implemented method of claim 15, wherein the second data transmission is received via a short range communication channel between a user access device and an entity device, wherein the user access device comprises at least one of: a mobile device, an access card, a key, or a key fob.

20. The computer-implemented method of claim 15, wherein the user device is associated with a first distributed computing system and wherein the resource is stored in a second distributed computing system.
